(19) United States
(12) Patent Application Publication
(10) Pub. No.: US 2014/0086684 A1
(43) Pub. Date: Mar. 27, 2014

(54) DEVICE FOR DETECTING THE TEMPERATURE OF AN ASPHALT MATERIAL TO BE PROCESSED BY A ROAD FINISHING MACHINE, ULTRASONIC SENSOR AND ROAD FINISHING MACHINE

(71) Applicant: MOBA Mobile Automation AG, Limburg (DE)

(72) Inventors: Willibald SEHR, Hadamar (DE); David SHELSTAD, Big Lake, MN (US)

(73) Assignee: MOBA Mobile Automation AG, Limburg (DE)

(21) Appl. No.: 14/036,446

(22) Filed: Sep. 25, 2013

(30) Foreign Application Priority Data
Sep. 27, 2012 (DE) 20 2012 009 335.5
Feb. 4, 2013 (DE) 10 2013 201 762.6

(51) Int. Cl. G01K 11/22; G01F 23/296; E01C 19/08

(52) U.S. Cl. CPC G01K 11/22; E01C 19/08; G01F 23/296
USPC 404/84.05; 374/117; 73/290 V

(57) ABSTRACT

A device for detecting the temperature of an asphalt material to be processed by a road finishing machine includes at least one temperature measuring head, the at least one temperature measuring head being integrated into an ultrasonic sensor for detecting the filling level of the asphalt material.

### CROSS-REFERENCE TO RELATED APPLICATIONS

This application claims priority from German Patent Application No. 10 2013 201 762.6, filed Feb. 4, 2013, and from German Utility Model Application No. 20 2012 009 335.5, filed Sep. 27, 2012, which are both incorporated herein by reference in their entirety.

### BACKGROUND OF THE INVENTION

The present invention relates to the field of road finishing machines or asphalt finishing machines and, in particular, to the detection of a filling level and the detection of a temperature of the asphalt material to be processed. Embodiments relate to the combination of an ultrasonic sensor and an infrared temperature measuring element for worm or grid control of a road or asphalt finishing machine.

FIG. 1 shows an illustration of a known road finishing machine 100 serving to apply one or several layers of an asphalt material 104 onto a prepared surface 102. The road finishing machine 100 includes a container arranged on a front end 108 of the road finishing machine 100 and serving for receiving the asphalt material to be processed. An insert plank 112 serving to apply the asphalt material to be processed onto the prepared surface 102 over the entire insert width is arranged in the back part 110. A worm conveyor 114 is provided in the back part 110 of the finishing machine 100 so as to ensure uniform distribution of the material in front of the insert plank 112. The material to be processed is conveyed from the container 106 to the worm conveyor 114 by means of a conveyor belt 116, exemplarily a flight conveyor belt moving back and forth. The finishing machine 100 additionally includes a controller 118 which is illustrated schematically in FIG. 1. Additionally, an ultrasonic sensor 120 is arranged in the transition region from the conveyor 116 to the worm 114. The different sensors within the finishing machine, including the sensor 120, are connected to the controller 118 which in turn is configured to drive the drive, which is not shown in greater detail, and the conveyor belts and conveyor distances based on the sensor signals detected of different elements of the road finishing machine.

FIG. 2 is an enlarged illustration of the back part 110 of the finishing machine of FIG. 1. A direction of motion of the finishing machine is indicated by the arrow 122. Additionally, it can be recognized that the asphalt material is moved in the direction of the back part of the finishing machine by means of the conveyor belt 116, more precisely in the direction of the worm 114, and is distributed over the width of the finishing machine by means of the worm 114 so as to be applied onto the prepared surface 102 by means of the insert plank 112. FIG. 2 shows the arrangement of the sensor 120 with respect to the conveyor 116 and with respect to the worm 114. The sensor 120 is arranged at a position above the worm 114 such that the ultrasonic energy thereof is directed to the top region of the conveyor worm 114, as is indicated by arrows 126a, 126b, so as to detect a filling level of the asphalt material 104 above the conveyor worm 114.

Using the ultrasonic sensor 120 shown in FIG. 2 for controlling the number of revolutions of the conveyor worm 114 and/or the conveyor belt 116 is known, wherein one or several ultrasonic sensors shown may be arranged so as to be distributed over the width of the conveyor worm. The hot asphalt material or mix 104 is conveyed by means of the conveyor belts 116 from the container 106 to the back part 110 of the machine and distributed there uniformly onto the sides by means of the conveyor worm 114. The filling level of the material 104 above the worm is measured by means of the ultrasonic sensor 120 so as to ensure a sufficient amount of material to be available always, and the number of revolutions of the conveyor worm is adjusted in dependence on the measuring result.

The temperature of the material 104 is an important criterion for the quality of the future road surface, apart from a uniform filling level of the material 104 above the worm 114. The asphalt mix is prepared in a mixing plant and trucks comprising heat-insulated containers transport the material from the mixing plant to the finishing machine. At the finishing machine, the material is filled into the container 106. The material 104 is subjected to cooling effects of a greater or lesser extent on the way from the mixing plant to the finishing machine, caused by the transport distance, the duration of the transport, the outside temperature or the effectivity of insulation.

It is necessary to again check the temperature of the mix at the finishing machine so as to ensure the road surface to be generated to exhibit the quality desired. Providing conventional measuring devices at corresponding positions within the finishing machine is known, however entailing high complexity with regard to mounting and additional wiring.

### SUMMARY

According to an embodiment, a device for detecting the temperature of an asphalt material to be processed by a road finishing machine comprises: at least one temperature measuring head, characterized in that the at least one temperature measuring head is integrated into an ultrasonic sensor for detecting the filling level of the asphalt material.

Another embodiment may have an ultrasonic sensor for detecting the filling level of an asphalt material to be processed by a road finishing machine, characterized by a temperature measuring head for detecting the temperature of the asphalt material.

According to another embodiment, a road finishing machine may have: a device for detecting as mentioned above or an ultrasonic sensor as mentioned above for detecting the filling level and the temperature of the asphalt material to be processed.

In accordance with embodiments, the device includes a casing in which are arranged one or several ultrasonic transducers and the at least one temperature measuring head.

In accordance with embodiments, the ultrasonic transducer and the temperature measuring head are heading in the same direction.

In accordance with embodiments, the device includes a terminal connected effectively to the ultrasonic sensor and the temperature measuring head so as to provide corresponding measuring signals, exemplarily in the form of a digital interface or an analog interface.

In accordance with embodiments, the temperature measuring head includes a contactlessly operating temperature sensor, such as, for example, an infrared sensor.

In accordance with embodiments, the device includes a controller electrically connected to the ultrasonic sensor so as to receive the measuring signals from the ultrasonic sensor and the temperature measuring head and generate and output control signals for the road finishing machine based on the measuring signals.

In accordance with embodiments, the road finishing machine includes a conveyor worm for distributing an asphalt material to be processed, the device or the ultrasonic sensor being arranged so as to detect the filling level and the temperature of the asphalt material to be processed above the conveyor worm.

What is provided in accordance with the present invention is an approach allowing detecting a temperature of an asphalt material to be processed by a road finishing machine, in addition to the filling level, in an easy manner, avoiding unnecessary complexity and unnecessary wirings, and outputting corresponding measuring signals to a central controller which may then, in dependence on the temperatures detected, generate corresponding control signals for operating the road finishing machine and output same to corresponding elements of the road finishing machine. The invention provides a device for detecting the temperature of the asphalt material to be processed which includes a temperature measuring head, preferably a contactless infrared measuring head which is integrated into the existing ultrasonic sensor described before. Thus, embodiments of the present invention provide an approach of using an existing ultrasonic sensor in which a contactless infrared sensor is integrated into the existing ultrasonic measuring head. In accordance with embodiments, the ultrasonic sensor may comprise a digital interface, which is of advantage in that the additional sensor element, implemented as the temperature measuring sensor, does not entail additional wiring since only an additional address has to be provided using the digital interface, by means of which the temperature information are provided. In further embodiments, an analog interface may be provided which is connected to a central controller via a multicore wire so as to provide corresponding control signals or measuring signals to the ultrasonic measuring head or output same therefrom. Normally, the wire present includes one or several cores which are unused so that, even when using an analog interface, the wiring complexity may be reduced since an additional core of the wire, which is present anyway but has not been used up to then, may be resorted to.

Additionally, the inventive approach is of advantage since it allows easy mounting since detecting the level and detecting the temperature are performed at the same time, when inserting a sensor element. Correspondingly, inserting two sensors is no longer necessary.

### BRIEF DESCRIPTION OF THE DRAWINGS

Embodiments of the present invention will be detailed subsequently referring to the appended drawings, in which:

FIG. 1 is an illustration of a known road finishing machine;

FIG. 2 is an enlarged illustration of the back part of the finishing machine of FIG. 1; and

FIG. 3 is a schematic illustration of the inventive device and inventive ultrasonic sensor in accordance with an embodiment of the present invention.

### DETAILED DESCRIPTION OF THE INVENTION

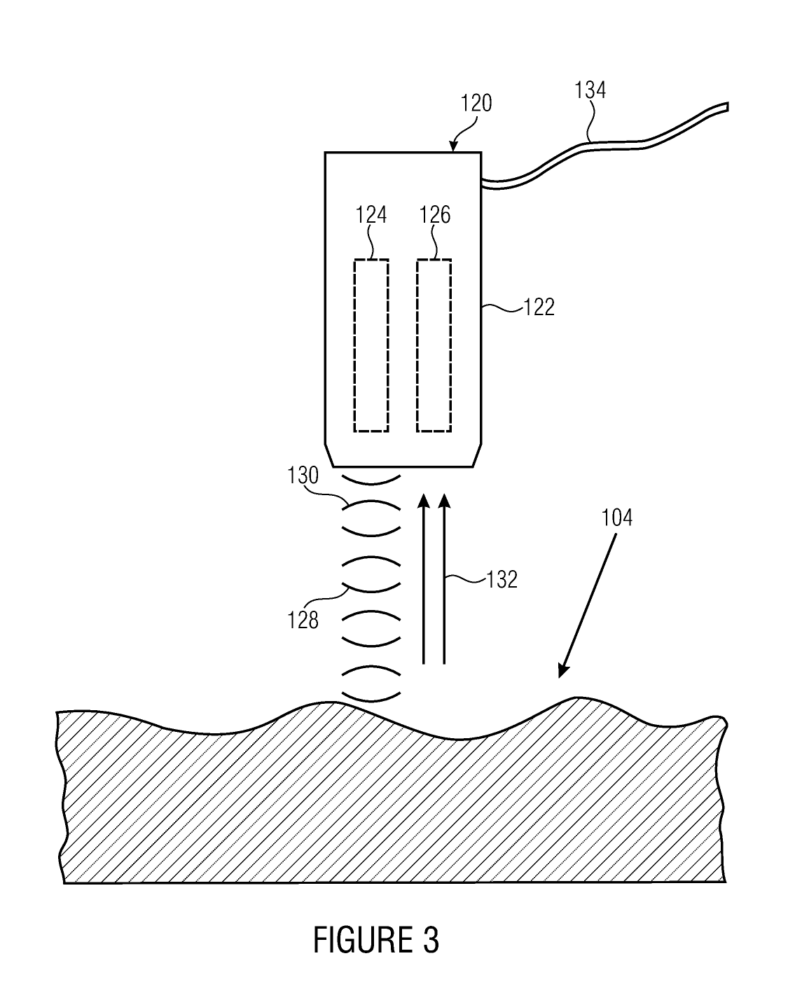

FIG. 3 shows a schematic illustration of the inventive device and the inventive ultrasonic sensor in accordance with an embodiment of the present application. What is shown in FIG. 3 is the sensor 120 comprising a casing 122 in which are arranged one or several ultrasonic transducers 124 and one or several temperature measuring heads 126. The temperature measuring head 126 may exemplarily include one or several contactless sensors, exemplarily infrared sensors. The sensors 124, 126 are arranged to be oriented in the same measuring direction, the transducer 124 emitting ultrasonic signals 128 and receiving the ultrasonic energy 130 reflected at the filling material 104. The temperature measuring head 126 receives the heat radiation 132 emitted by the filling material 104. The sensor 120 is connected to the controller of the road finishing machine via a suitable electrical connection 134, exemplarily a multicore wire, so as to pass on to same the measuring signals from the sensors 124, 126 to be processed further by the controller. Additionally, the sensor 120 receives signals for driving the sensors via the connection 134, exemplarily for switching the ultrasonic transducer between transmitting operation and receiving operation.

A runtime measurement may be performed based on the ultrasonic signals 128, 130, based on which the level of the filling material 104 with regard to a reference level may be determined. A corresponding temperature measuring signal is generated by the sensor 126, and passed on to the controller, based on the heat radiation 132 emitted by the filling material 104.

In the embodiment described above, the ultrasonic sensor 120 includes an ultrasonic transducer and a temperature measuring head, wherein it is to be mentioned that the present invention is not limited to such an implementation. Rather, several ultrasonic transducers and several temperature sensors may also be provided.

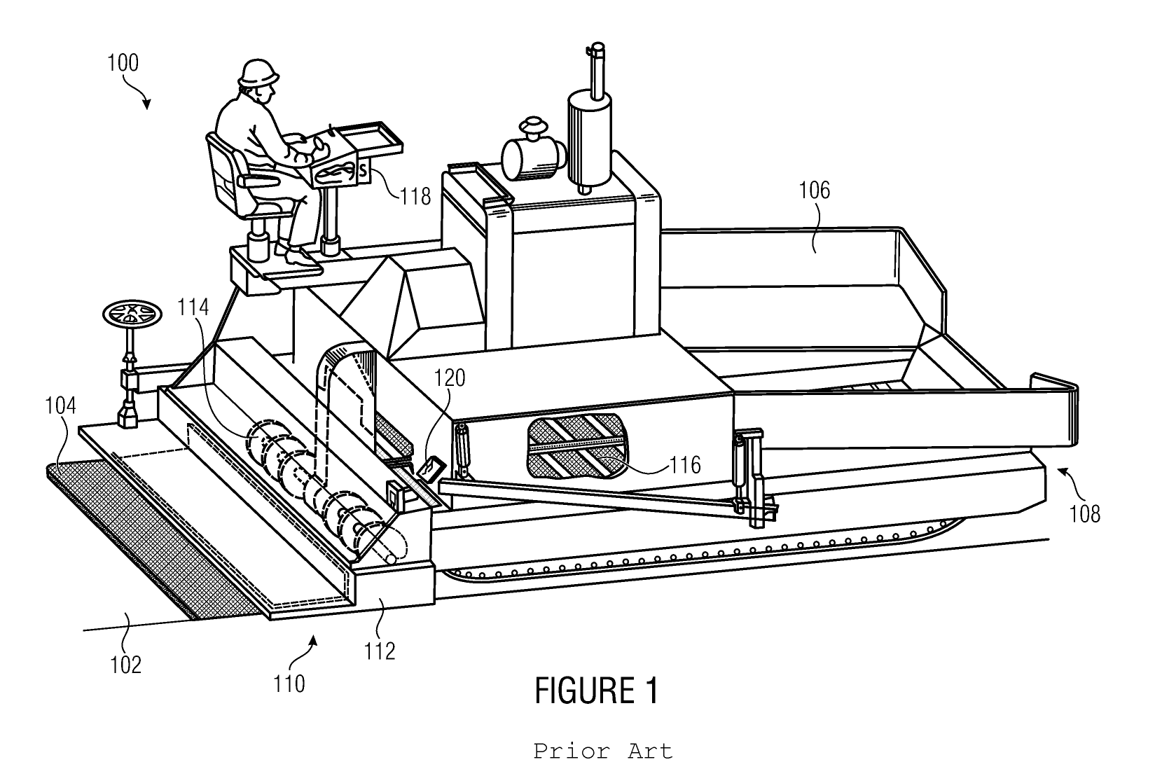

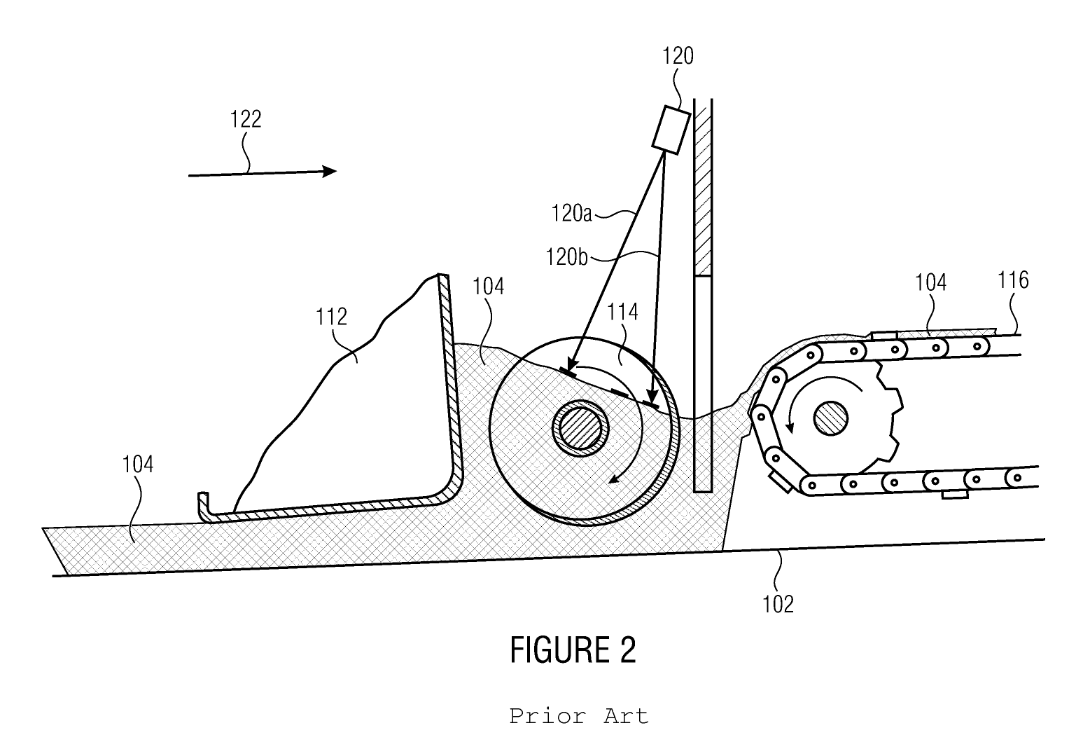

An ultrasonic transducer 120 as has been described with reference to FIG. 3, may be used in a road finishing machine, as has been described with reference to FIGS. 1 and 2, at the position mentioned. In accordance with embodiments, several of the sensors shown in FIG. 3 may exemplarily be arranged over the width of the conveyor worm at certain distances from one another. Alternatively, the inventive sensor may also be arranged at different positions of the finishing machine, exemplarily in the region of the container or along the conveyor 116, so as to detect there the filling level and temperature of the material. Several of the inventive sensors may also be provided.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A device for detecting the temperature of an asphalt material to be processed by a road finishing machine, comprising:
at least one temperature measuring head,
characterized in that
the at least one temperature measuring head is integrated into an ultrasonic sensor for detecting the filling level of the asphalt material.

2. The device in accordance with claim 1, comprising a casing in which are arranged one or several ultrasonic transducers and the at least one temperature measuring head.

3. The device in accordance with claim 2, wherein the ultrasonic transducer and the temperature measuring head are heading in the same direction.

4. The device in accordance with claim 2, comprising a terminal which is connected effectively to the ultrasonic sensor and the temperature measuring head so as to provide corresponding measuring signals.

5. The device in accordance with claim 4, wherein the terminal includes a digital interface or an analog interface.

6. The device in accordance with claim 1, wherein the temperature measuring head includes a contactlessly operating temperature sensor.

7. The device in accordance with claim 6, wherein the contactlessly operating temperature sensor includes an infrared sensor.

8. The device in accordance with claim 1, comprising a controller which is connected electrically to the ultrasonic sensor so as to receive the measuring signals from the ultrasonic sensor and the temperature measuring head and generate and output control signals for the road finishing machine based on said measuring signals.

9. An ultrasonic sensor for detecting the filling level of an asphalt material to be processed by a road finishing machine,
characterized by
a temperature measuring head for detecting the temperature of the asphalt material.

10. A road finishing machine comprising:
a device in accordance with claim 1 or an ultrasonic sensor for detecting the filling level of an asphalt material to be processed by a road finishing machine, characterized by a temperature measuring head for detecting the temperature of the asphalt material, for detecting the filling level and the temperature of the asphalt material to be processed.

11. The road finishing machine in accordance with claim 10 comprising:
a conveyor worm for distributing an asphalt material to be processed,
wherein the device or the ultrasonic sensor are arranged to detect the filling level and the temperature of the asphalt material to be processed above the conveyor worm.
